(19) United States
(12) Patent Application Publication
(10) Pub. No.: US 2023/0296491 A1
(43) Pub. Date: Sep. 21, 2023

(54) DEVICE AND METHOD FOR DETERMINING A MECHANICAL PROPERTY OF A PARTICLE

(71) Applicant: SINGAPORE UNIVERSITY OF TECHNOLOGY AND DESIGN, Singapore (SG)

(72) Inventors: Ye AI, Singapore (SG); Minhui LIANG, Singapore (SG)

(21) Appl. No.: 18/041,724

(22) PCT Filed: Aug. 25, 2021
(86) PCT No.: PCT/SG2021/050506

§ 371 Date: Feb. 15, 2023

(30) Foreign Application Priority Data
Aug. 25, 2020 (SG) 10202008180X

(51) Int. Cl. G01N 15/14

(52) U.S. Cl. CPC G01N 15/1427; G01N 15/1404; G01N 15/147; G01N 15/1475; G01N 15/1484; G01N 2015/1413; G01N 2015/1497

(57) ABSTRACT

The present invention relates to a device and method for high-throughput single cell stretching with the hydrodynamic force for assessing cellular mechanical properties. In an aspect of the invention, there is provided a uniquely designed microfluidic channel flowing with viscoelastic fluids, sensing electrodes integrated with the microchannel and a high-speed imaging and processing system. Cells are continuously pumped in the device, aligned and stretched. The arrival of individual cells prior to the cell stretching site can be detected by the electrical sensing unit, which produces a triggering signal to activate a high-speed camera for on-demand imaging of the cell motion and deformation. Cellular mechanical properties including cell size and cell deformability are extracted from the analysis of these captured single cell images.

The present invention relates to a device and method for high-throughput single cell stretching with the hydrodynamic force for assessing cellular mechanical properties. The invention consists of a uniquely designed microfluidic channel flowing with viscoelastic fluids, three sensing electrodes integrated with the microchannel and a high-speed imaging and processing system. Cells are continuously pumped in the device, aligned and stretched. The arrival of individual cells prior to the cell stretching site can be detected by the electrical sensing unit, which produces a triggering signal to activate a high-speed camera for on-demand imaging of the cell motion and deformation. Cellular mechanical properties including cell size and cell deformability are extracted from the analysis of these captured single cell images. This invention provides a solution to high-throughput cellular mechanical phenotyping for label-free single cell analysis in diverse biomedical applications.

Cellular mechanical phenotypes have been brought to the fore as a new type of label-free biomarkers associated with changes in the cytoskeleton and nuclear organization. It is promising to indicate cell state and disease, such as stem cell differentiation, aging, malignancy and metastatic potential, sepsis and posttraumatic stress. As an example, lymphocytes decrease in stiffness upon activation. This phenomenon is postulated to be essential for transmigration through the tissue to the infected position. Thus, a label-free method for mechanical phenotyping of lymphocytes have the potential to be a clinical indicator relate to chronic lymphocytic leukemia, viral infection and autoimmune disorders.

Conventionally, the characterization of cellular heterogeneity using molecular marker involves cumbersome sample preparation steps, skilled technicians and costly reagents. Notably, the simple label-free assay has the potential to address these problems, spawning many research approaches as discussed in previously work: atomic force microscopy, micropipette aspiration and optical stretching. These techniques offer high precision of cell stiffness measurement, but the throughput is low, only achieving 6, 20, 300 cells/hr for micropipette aspiration, atomic force microscopy, optical stretching, respectively. However, a throughput comparable with flow cytometry (>1000 cells/s) is crucial due to the cellular heterogeneity existing within the cell isogenic population, as a large amount of data is required for a statistically valid result.

Alternatively, microfluidics-based methods enabling high throughput cellular mechanophenotyping provide promising solutions for these challenges. As discussed in recent publications, there are three major classes of microfluidic cellular mechanophenotyping techniques. One major class employs constriction smaller than cells and characterizes the deformation by the transit time required for cells to pass through the constriction. There are multiple approaches to measure transit time, such as measuring the mechanical frequency changes of suspended microchannel resonator, using optical imaging to visualize cells deformation, or investigating electrical impedance. Nevertheless, the non-contactless working principle leads to two problems: the constriction can cause clogging, and the transit time is not independent of the cell size and adhesiveness between the channel walls and cell. The other two major classes are contactless, real-time deformability cytometry (RT-DC) and deformability cytometry (DC). RT-DC stretches cells to a bullet shape in a long constriction with shear stress and pressure gradients, and can operate at low flow velocity (e.g., 0.15 m/s) and low frame rate (e.g., 4,000 images/s). However, RT-DC only provides a low stretch force which leads to a low degree of cell deformation. Moreover, a cumbersome sheath flow is required, and the constriction structure can possibly cause clogging. In addition, DC employs a cross-slot microchannel forming an extensional flow at a stagnation point located in the center of the crossing channel, and the cells passing through the stagnation point are subjected to both pressure drag and shear force. Another important structure in DC, is the inertial microfluidic cell stretcher (iMCS). Uses a flow splitting junction to employ extensional flow, eliminating the cell horizontal drifting existing in the cross-slot structure. In DC, the pressure drag force is greater than 1 μN, while the shear force is negligible. A high flow velocity of 3.5 m/s is required to achieve a sufficient impact force. As a result, to capture an image with good quality, a high frame rate and fast shuttle are necessary. A frame rate of up to 100,000 images/sec with an exposure time of 1 μs is required to implement DC. Under this circumstance, a considerably expensive high-level high-speed camera, and intensive high-power illumination become an entry barrier that hinders DC to be a widespread biological research method. A few works applied viscoelastic fluids to decrease the required flow velocity in the cross-slot structure successfully. However, the cell concentration is kept low to ensure one cell passes the stagnation point each time. It guarantees a uniform stretching force but leads to a large number of invalid images. With respect to imaging processing, a large number of image stacks are generated, especially DC operating at a high frame rate where 100,000 frames are generated in one second. Many frames do not contain a cell among the enormous image stacks, and only a few numbers of frames with cell translocation events are useful to extract information that correlates with cell deformability. The method that relies on real-time image processing to discard invalid frames takes up memory space and processing time. Thus, it is not feasible under such a high frame rate.

The listing or discussion of an apparently prior-published document in this specification should not necessarily be taken as an acknowledgement that the document is part of the state of the art or is common general knowledge.

Any document referred to herein is hereby incorporated by reference in its entirety.

Cellular mechanical phenotypes in connection to physiological and pathological states of cells have become a promising intrinsic biomarker for label-free cell analysis in various biological research and medical diagnostics. In this invention, a microfluidic system capable of high-throughput cellular mechanical phenotyping based on rapid single cell hydrodynamic stretching in a continuous viscoelastic fluid flow is presented. Randomly introduced single cells are firstly aligned into a single streamline in viscoelastic fluids before guided to a flow splitting junction for consistent hydrodynamic stretching. The arrival of individual cells prior to the flow splitting junction can be detected by an electrical sensing unit, which produces a triggering signal to activate a high-speed camera for on-demand imaging of the cell motion and deformation through the flow splitting junction. Cellular mechanical phenotypes, including cell size and cell deformability, are extracted from the analysis of these captured single cell images. The sensitivity of the developed microfluidic mechanical phenotyping system was evaluated by measuring synthesized hydrogel microbeads with known Young's modulus. With this microfluidic cellular mechanical phenotyping system, the statistical difference in deformability of microfilament disrupted, normal and fixed NIH 3T3 fibroblast cells was revealed. Furthermore, with the implementation of a machine learning-based classification of MCF-10A and MDA-MB-231 mixtures, our label-free cellular phenotyping system has achieved a comparable cell analysis accuracy (0.9:1, 5.03:1) with respect to fluorescence-based flow cytometry results (0.97:1, 5.33:1). The presented microfluidic mechanical phenotyping technique will open new avenues for high-throughput and label-free single cell analysis in diverse biomedical applications.

In a first aspect of the invention, there is provided a device for determining a mechanical property of a particle in a fluid suspension, the device comprising: (a) at least one inlet for introducing the fluid suspension; (b) at least one outlet for discharging the fluid suspension; (c) a channel in fluid communication with and intermediate the at least one inlet and the at least one outlet, the channel comprising first, second and third sections, the second section disposed intermediate the first and third portions, wherein (i) the first section is disposed adjacent the at least one inlet, a portion of the first section is curved to form at least one curved unit; (ii) the third section is adjacent the outlet, the third section comprises a junction wherein the channel splits to form at least two divergent channels that converges into a single channel extending to the at least one outlet; and (iii) the second section comprises an electrical sensing zone; (d) at least one electrode disposed adjacent the electrical sensing zone; (e) an image capturing device disposed adjacent the junction to capture an image of the particle as it passes through the junction, wherein the at least one electrode is configured to detect the presence of the particle arriving at the junction and, upon detection of the particle, to generate a trigger signal to the image capturing device to capture the image of the particle.

By “channel”, it is meant to refer to any feature on or in (or defined) in the substrate that at least partially directs flow of the fluid. The channel can have any cross-sectional shape (circular, oval, triangular, irregular, square or rectangular, or the like) and can be covered or uncovered. In embodiments where it is completely covered, at least one portion of the channel can have a cross-section that is completely enclosed, or the entire channel may be completely enclosed along its entire length with the exception of its inlet(s) and/or outlet(s). A channel may also have an aspect ratio (length to average cross sectional dimension) of at least 2:1, more typically at least 3:1, 5:1, 10:1, 15:1, 20:1, or more. An open channel generally will include characteristics that facilitate control over fluid transport, e.g., structural characteristics (an elongated indentation) and/or physical or chemical characteristics (hydrophobicity vs. hydrophilicity) or other characteristics that can exert a force (e.g., a containing force) on a fluid. The fluid within the channel may partially or completely fill the channel. In some cases where an open channel is used, the fluid may be held within the channel, for example, using surface tension (i.e., a concave or convex meniscus). By “channel device”, it is meant to include any device comprising the channel. It also includes, the channel itself comprising any inlets and outlets. In the present invention, the terms “channel”, “microfluidic channel” and “microchannel” may be used interchangeably.

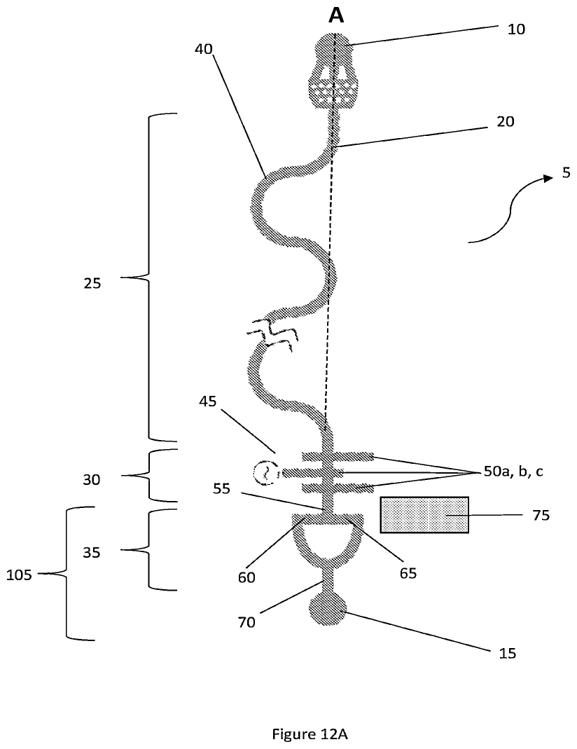

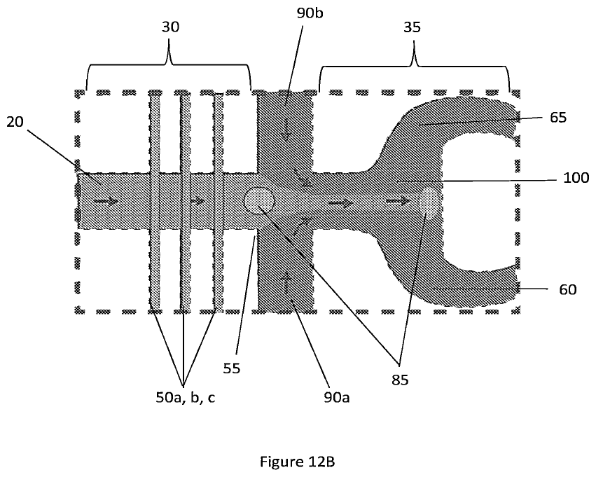

“By curved”, it is meant to include any turning or bending of the channel to form a curve. For example, the channel may bend to form curves or waves to create a semi-circular configurations. In various embodiments, assuming an imaginary line (a “main axis” as shown in dotted line A in FIG. 12A) linking the at least one inlet and the at least one outlet, the curved unit comprises a curved portion of the channel that forms a circular configuration about this main axis.

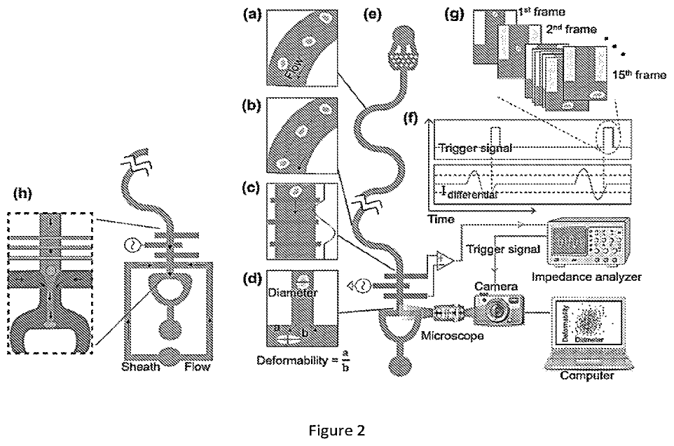

In various embodiments, the first section is sinuous comprises a plurality of curved units. By “sinuous”, it is meant to include that the first section of the channel is wavy and curvy, e.g. having many turns. In various embodiments, the first section comprises 12 curved units, each curved unit comprises a curvature radius between 50 μm to 500 μm. Each curved unit may form part of circle and the curvature radius is that line segment from its imaginary center to the axial centerline (i.e. that imaginary line running along the center of the channel as shown in FIG. 2(b) as the dotted line).

In various embodiments, the device comprises a plurality of electrodes are disposed transverse the channel. The plurality of electrodes may comprise 3 electrodes, a first, second and third electrodes, the second electrode is disposed intermediate the first and third electrodes, each electrode may be about 5-30 μm in width and the distance between each electrode is about 5-30 μm. In various embodiments, a current having an input voltage of about 0.1-10 V a frequency of about 0.1-50 MHz is applied to the second electrode and a differential current is calculated across the first and third electrodes.

The channel may be of any size, for example, having a largest dimension perpendicular to fluid flow of less than about 5 mm or 2 mm, or less than about 1 mm, or less than about 500 microns, less than about 200 microns, less than about 100 microns, less than about 60 microns, less than about 50 microns, less than about 40 microns, less than about 30 microns, less than about 25 microns, less than about 10 microns, less than about 3 microns, less than about 1 micron, less than about 300 nm, less than about 100 nm, less than about 30 nm, or less than about 10 nm. In a preferred embodiment, the width of the microfluidic channel is about between 10 μm and 1000 μm, and the height of the channel is about 1 μm to 100 μm. In some cases the dimensions of the channel may be chosen such that fluid is able to freely flow through the article or substrate. The dimensions of the channel may also be chosen, for example, to allow a certain volumetric or linear flowrate of fluid in the channel. In some cases, more than one channel may be used for a single device.

The wall of the microfluidic channel wall may be of any thickness. In various embodiments, the wall may be as thin as about between 5 μm to 100 μm, considering the wave attenuation, fabrication feasibility, and sealability of the channel.

In various embodiments, the width and height of the channel are about 80 and 38 μm respectively. The channel may be made of polydimethylsiloxane.

In various embodiments, the device further comprises two inlets that are disposed perpendicular to and each on opposite sides of the channel intermediate the second and third sections. The two inlets are in fluid communication with the channel and allows for the introduction of a sheath flow to the channel for aligning the particles towards the center of the channel. As will be explained in further detail below, the sheath flow helps to further focus or align the particles traveling in the channel towards the center of the channel, and eventually towards the center of the junction of the third section of the channel.

In various embodiments, when triggered, the image capturing device is configured to record a series of frames at a rate of 1,000-10,000 frames per second, with an exposure time of about 50 μs for each frame.

In various embodiments, the third section of the channel which splits to form at least two divergent channels that converges into a single channel forms a substantially symmetrical configuration. In various embodiments, the third section forms a substantially D-shaped configuration. By “substantially D-shaped”, it is meant to refer to a configuration or shape that generally adopts the letter D. It should be appreciated that, by “substantially”, it is intended to encompass a reasonable variance. For example, the third section may be substantially O-shaped, round-shaped, or square-shaped. In particular, the configuration and shape of the third section is symmetrical. By “symmetrical”, it is meant to include that the two divergent channels that eventually converges into a single channel face opposite each other or around an imaginary axis and are substantially symmetrical, i.e. having substantially the same dimension and proportions.

In various embodiments, the third section and outlet of the device forms an outlet section and, the channel intermediate the second and third section splits to form a plurality of outlet sections.

In various embodiments, compared to the first section of the channel, the second section of the channel is substantially straight. “By substantially straight”, it is meant to include “not curved”. It may also mean that the channel of the second section runs substantially parallel to the main axis A shown in FIG. 12A. By “center”, it is meant to refer to the center middle portion of the channel, i.e. the point that is bounded by the walls of the channel and substantially equidistant from said walls. By “centerline”, it is meant to refer to the imaginary line running the center and length of the channel.

In various embodiments, the device further comprises a pump, the pump is configured to continuously introduce the fluid suspension into the inlet at a flow rate of about 10 to 30 μl/min. The pump may be a syringe pump or any suitable pump capable to pushing the fluid suspension through the channel.

In various embodiments, the particle being investigated may be any particle such as organic particles, inorganic particles, biological cells, or microorganisms. The particle may also include any hydrogel particles.

By “cell”, it is meant to refer to its ordinary meaning as used in biology. The cell may be any cell or cell type. For example, the cell may be a bacterium or other single-cell organism, a plant cell, or an animal cell. If the cell is a single-cell organism, then the cell may be, for example, a protozoan, a trypanosome, an amoeba, a yeast cell, algae, etc. If the cell is an animal cell, the cell may be, for example, an invertebrate cell (e.g., a cell from a fruit fly), a fish cell (e.g., a zebrafish cell), an amphibian cell (e.g., a frog cell), a reptile cell, a bird cell, or a mammalian cell such as a primate cell, a bovine cell, a horse cell, a porcine cell, a goat cell, a dog cell, a cat cell, or a cell from a rodent such as a rat or a mouse. If the cell is from a multicellular organism, the cell may be from any part of the organism. For instance, if the cell is from an animal, the cell may be a cardiac cell, a fibroblast, a keratinocyte, a heptaocyte, a chondracyte, a neural cell, a osteocyte, a muscle cell, a blood cell, an endothelial cell, an immune cell (e.g., a T-cell, a B-cell, a macrophage, a neutrophil, a basophil, a mast cell, an eosinophil), a stem cell, etc. In some cases, the cell may be a genetically engineered cell. In various embodiments, the cells may be breast cancer cells or MDA-MB-231.

In a second aspect of the invention, there is provided a method for determining a mechanical property of a particle in a fluid suspension, the method comprising: (a) allowing the fluid suspension to flow through a channel, the channel comprising first, second and third sections, wherein the first section comprising at least one curved unit, the second section comprising an electrical sensing zone, and the third section comprises a junction wherein the channel splits to form at least two divergent channels; and (b) detecting the presence of the particle arriving at the junction and, upon detection of the particle, generating a trigger signal to an image capturing device to capture the image of the particle.

In various embodiments, the first section is sinuous and may comprise a plurality of curved units. This provides a wavy or winding path for the fluid to flow through. The first section may comprise 12 curved units, each curved unit comprises a curvature centerline radius between 50 μm to 500 μm.

In various embodiments, the particle is suspended in a viscoelastic fluid, the method may further comprise aligning the particle to the center of the channel by viscoelastic forces. The viscoelastic fluid may be 0.5 to 3 wt % PEO. In various embodiments, the viscoelastic fluid is 2 wt % PEO.

In various embodiments, 3 electrodes are disposed transverse the channel adjacent the electrical sensing zone allowing for the detecting of the presence of the particle arriving the junction, the 3 electrodes may comprise a first, a second and third electrodes, the second electrode is disposed intermediate the first and third electrodes, each electrode is about 5-30 μm in width and the distance between each electrode is about 5-30 μm. In order to generate the trigger signal, a current having an input voltage of 0.1-10 V and a frequency of 0.1-50 MHz may be applied to the second electrode and the method comprises calculating a differential current across the first and third electrodes.

In various embodiments, when triggered, the image capturing device records 15 frames at a rate of 2,000 frames per second, with an exposure time of about 50 μs for each frame.

In various embodiments, the width and height of the microchannel are about 80 and 38 μm respectively, and the channel is made of polydimethylsiloxane.

In various embodiments, the second section is substantially straight so that the fluid suspension is allowed to flow in a substantially straight alignment allowing the electrodes to detect the particles suspended in the fluid suspension.

In various embodiments, the method comprises introducing a sheath flow into the channel perpendicular to and on opposite sides of the channel intermediate the second and third sections, the sheath flow for aligning the particles towards the center of the channel.

In various embodiments, the junction of the third section of the channel is formed by splitting the channel into at least two divergent channels that converges into a single channel extending to an at least one outlet, the junction third section forms a substantially symmetrical configuration. In various embodiments the third section of the channel forms a substantially D-shaped configuration.

In various embodiments, the third section and outlet form an outlet section, and wherein the channel intermediate the second and third section splits to form a plurality of outlet sections allowing for a plurality of junctions for the capturing of images of particles passing through the junctions. In various embodiments, each outlet section may have its own dedicated image capturing device to capture the image of particles travelling through its junction.

In various embodiments, the fluid is allowed to flow continuously flow though the channel at a flow rate of about 10 to 30 μl/min.

Advantageously, this invention carries out high-throughput single cell stretching with the hydrodynamic force for assessing cellular mechanical properties. In an embodiment, the invention consists of a uniquely designed microfluidic channel flowing with viscoelastic fluids, three sensing electrodes integrated with the microchannel and a high-speed imaging and processing system. Particles, e.g. cells, can be continuously fed or pumped in the device, aligned and stretched. The arrival of individual cells prior to the cell stretching site (third section junction) can be detected by the associated electrical sensing unit over the substantially straight electrical sensing zone, which produces a triggering signal to activate a high-speed camera for on-demand imaging of the cell motion and deformation. Cellular mechanical properties including cell size and cell deformability are extracted from the analysis of these captured single cell images. This invention provides a solution to high-throughput cellular mechanical phenotyping for label-free single cell analysis in diverse biomedical applications.

In order that the present invention may be fully understood and readily put into practical effect, there shall now be described by way of non-limitative examples only preferred embodiments of the present invention, the description being with reference to the accompanying illustrative figures.

In the Figures:

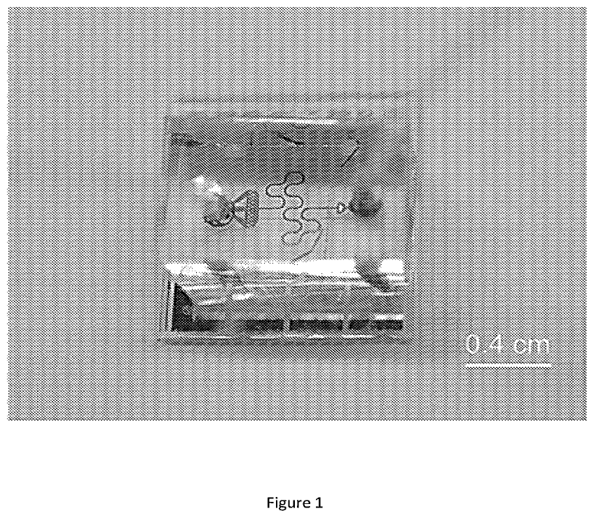

FIG. 1 is a photograph of the microfluidic device filled with blue dye.

FIG. 2 is an overview of the microfluidic system for high-throughput cellular mechanical phenotyping. Four processes of cells flowing through the channel: (a) cells enter the channel with a random distribution, (b) Cells are aligned to the channel center by viscoelastic force, (c) Cell passes the electrical sensing region and the corresponding current changes and (d) Cell enters the flow splitting junction and is stretched by hydrodynamic force. (e) Schematic illustration of the device operating principle. (f) The green line represents the differential current detected from the electrodes, which feeds into a real-time algorithm running in the impedance analyzer to generate the trigger signal (Red line) for on-demand high-speed camera imaging. (g) 15 frames of images for cell deformation analysis are recorded when the camera is triggered. (h) This figure shows an alternative embodiment with sheath flow to help focusing the cells. This embodiment is different from the one shown in (e) in two ways. The first is the introduction of sheath flow. The second is the enlarged outlet. And the rest of this design above the electrode is the same with the previous one. The arrows indicate the flow direction. The sheath flows perpendicularly to the main flow, pushing the cells to the centerline. This design can be helpful to focus extremely large or small cells. As illustrate in the left enlarged figure, the sheath flow is marked in a darker color to emphasize it from the main flow (as shown in the enlarged FIG. 12B). And other than the flow splitting junction in (d), (h) applied enlarged outlet to slow down the flow velocity for cell exiting the channel.

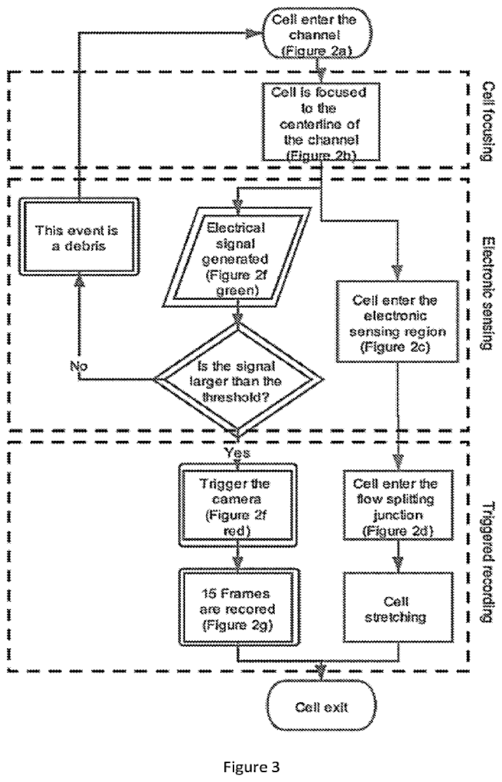

FIG. 3 is a flow chart of the microfluidic system for high-throughput cellular mechanical phenotyping. Two concurrent timelines are illustrated in this chart of the signal (double frame) and the cell migration (single frame). The dash boxes indicate the spatial position on the channel. For example, when a cell passes through the electric sensing zone, at the same time, the electrical signal is generated. If the signal is larger than the threshold, it will trigger the camera. If the signal is smaller than the threshold, system will recognize it as a debris.

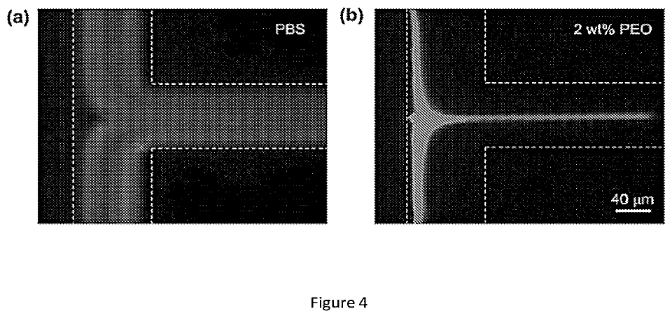

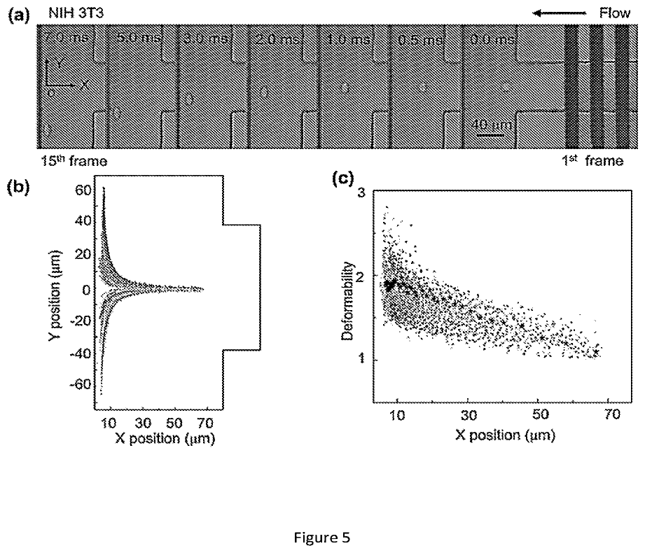

FIG. 4 shows particle focusing comparison in the PBS and 2 wt % PEO solution. 10 μm fluorescent beads were suspended in the PBS and PEO solution respectively, and ran into the device at a flow rate of 10 μl/min. (a) Beads are not focused in PBS. (b) Beads are focused well in a 2 wt % PEO solution. Objects migrate in Newtonian fluids mainly subject to shear-gradient lift, pushing the particles away from the low shear rate region. And the wall-repulsive force that pushes the particles away from the walls. Additionally, the curve channel provides a third force named the Dean drag force. The balancing between these forces generates equivalent positions in the channel for migrating particles. However, Newtonian flow (PBS) under this experiment condition is not able to reach particle focusing results. Under the same condition, viscoelastic fluids provide an additional elastic force that dominates the cells migration, which is able to focus the particles tightly along the centreline of the channel.

FIG. 5 shows NIH 3T3 trajectories at the flow splitting junction. (a) Representative images from one triggered loop showing the dynamic deformation of a single cell. (b) Trajectories of the single cells (N=200). (c) Scatter plot of deformability vs. x position of 200 cells. The black dots show the deformability changes with respect to the x position of one individual cell event with the deformability stable at the value of ˜1.8.

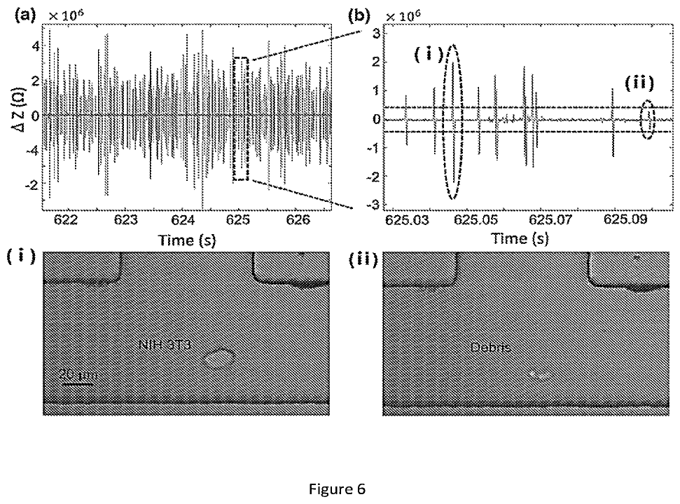

FIG. 6 shows an example of selective imaging by the on-demand electrical trigger. (a) Representative differential impedance signal of NIH 3T3 fibroblast cells measured at 10 μl/min. (b) An enlarged view of the impedance signal, demonstrating the cell event (i) is triggered, while the debris (ii) fails to reach the trigger level and is filtered out. By that, the on-demand imaging of cells of interest for selective cellular mechanical phenotyping was achieved. Representative (i) cell and (ii) debris image.

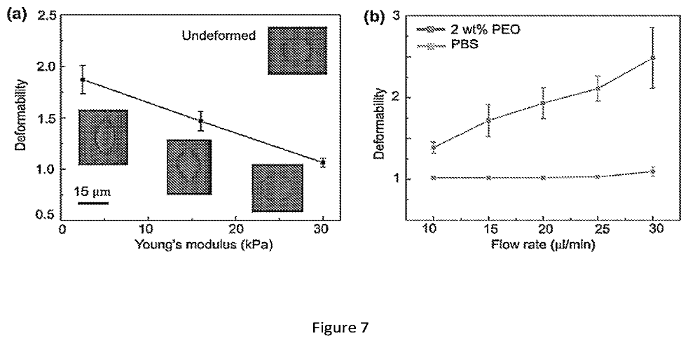

FIG. 7 shows deformability measurements of synthesized PEGDA hydrogel microbeads. (a) The deformability of three different hydrogels with different stiffness under the same experiment condition. Three representative images of deformed hydrogels are shown respectively and one typical image of the initial undeformed hydrogel is shown in the upper-right corner. (b) Deformability of hydrogels (Young's modulus of 2.5 kPa) under increasing flow rate in the medium of 2 wt % PEO and PBS, respectively. Data points represent means (N=˜100), and error bars represent standard deviation.

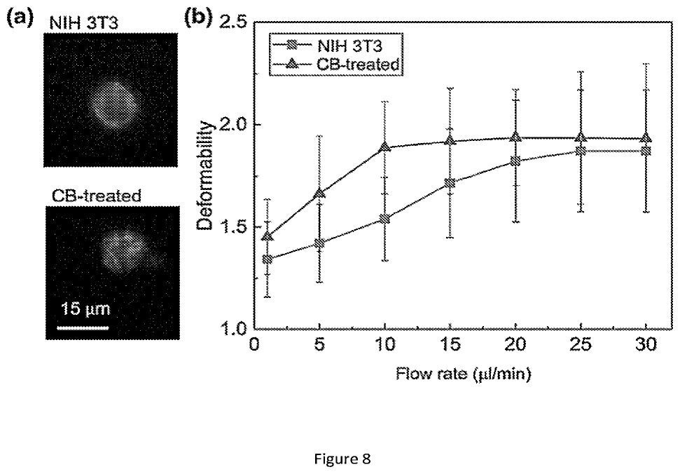

FIG. 8 shows strain response of normal and CB-treated NIH 3T3 fibroblast. (a) Representative fluorescence images (actin, red) of a live cell before (top) and after CB treatment (bottom). (b) Average deformability of normal and CB-treated NIH 3T3 fibroblasts under a flow rate range of 1-30 μl/min. Data points represent means (N=˜2000), and error bars represent standard deviation.

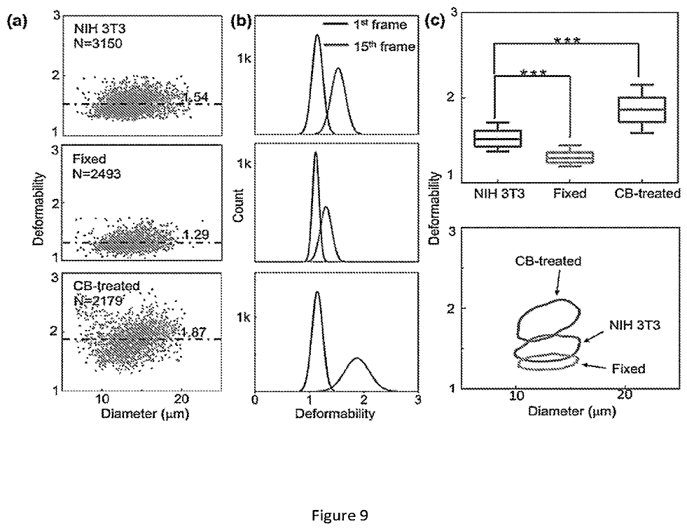

FIG. 9 shows deformability measurements of normal, fixed and CB-treated NIH 3T3 fibroblast at a flow rate of 10 μl/min. (a) Scatter plots of deformability vs. cell initial diameter, dash lines indicate median value. (b) Distribution curves of histograms comparing the deformability between the first and last frame of each recording cycle. (c) The top figure is a box chart of deformability. The box suggests the first quartile, median, and third quartile. The whiskers indicate the range of 1.5 interquartile range. *** indicate a p-value of less than 0.001 based on one way ANOVA test. The bottom figure shows the 50% density contour plots of the three types of differently treated cells.

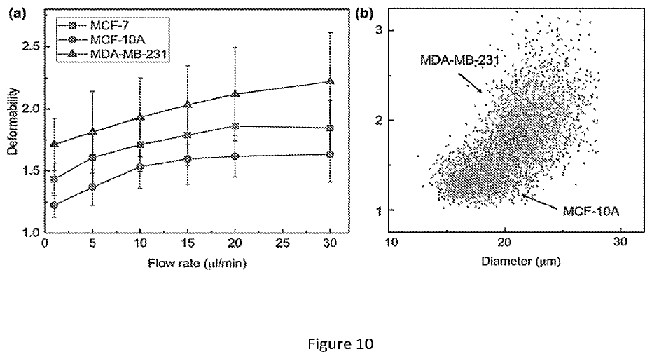

FIG. 10 shows deformability measurements of different types of breast cancer cells. (a) Average deformability of high invasive cancer cells MDA-MB-231, low invasive cells MCF-7, and normal MCF-10A. Data points represent means (N=˜2000), and error bars represent standard deviation. (b) Scatter plot of deformability vs. diameter of MCF-10A and MDA-MB-231 at a flow rate of 10 μl/min.

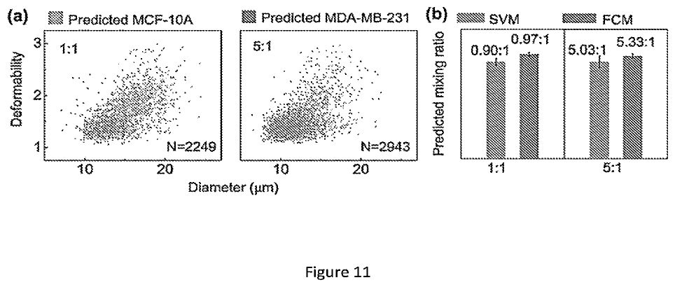

FIG. 11 shows classification of MDA-MB-231 and MCF-10A mixture. (a) Scatter plot of SVM predicted population. (b) Numerical results of SVM and FCM predicted mixing ratio (MCF-10A to MDA-MB-231) at 1:1 and 5:1. Whiskers indicate the standard deviation (N=3).

FIG. 12A shows an enlarged view of FIG. 2(e).

FIG. 12B shows an enlarged view of FIG. 2(h).

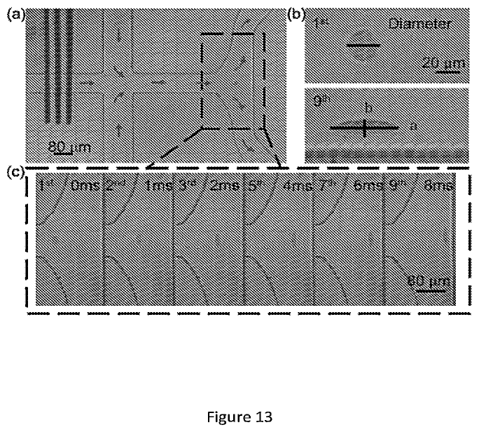

FIG. 13 shows the device according to another embodiment of the invention. (a) The difference of this device is the integration of sheath flow which comes perpendicularly with the flow direction to align cell into the centreline. This device compensates the focusing problem for some extremely larger or smaller cell in the first version of device. (b) The stretching of hydrogel in the first and 9^{th} frame. (c) The dynamic cell deformation in the successive 9 frames.

Here a hydrodynamic stretching system in viscoelastic fluids with an electrical triggered on-demand imaging technique for cellular mechanical phenotyping is introduced. It vastly decreases the required flow rate and the number of processing images. The microchannel 20 is a combination of a series of wavy structures and a flow splitting junction 55 (FIG. 1), cells suspended in viscoelastic fluids are pumped in at a range of flow rates, then aligned and stretched at a throughput up to 280 cells/s. The electrical sensing zone 45 is integrated here for on-demand image recording, which vastly decreases the required frame number for the mechanical phenotyping. Cell shape and deformability are extracted from these recorded cell images, and a 2D scatter plot is generated to reveal cellular mechanical phenotypes. In this invention, the indispensable role of viscoelastic fluids and triggering systems in single cell deformability assessment was discussed and addressed. Through this system, the cell deformability under a wide range of flow rates of 1-30 μl/min to visualize cell deformability response was measured. The deformability changes of cytochalasin B and formaldehyde-treated NIH 3T3 fibroblast cells were compared with normal cells. Classification between breast cancer cells (MDA-MB-231, MCF-7) and normal cells (MCF-10A) was analyzed and discussed. A machine learning-based method was applied to quantify the cell mixture ratio and showed comparable results with the fluorescent labeling based flow cytometry method.

With reference to FIG. 12A, there is provided a device 5 for determining a mechanical property of a particle in a fluid suspension according to an embodiment of the invention. The device 5 may also be referred to as a microfluidic system here.

The device 5 comprises an inlet 10, an outlet 15, and a channel 20 in fluid communication with and intermediate the inlet 10 and outlet 15. The channel 20 may have, loosely, 3 sections—a first section 25, a second section 30 and a third section 35. As is shown in FIG. 12A, the 3 sections are disposed in the order first 25, second 30 and third 35 starting with the first section 25 adjacent the inlet 10, the third section 35 adjacent the outlet 15, and the second section 30 disposed intermediate the first 25 and third 35 sections. The width and height of the channel 20 may be about 80 and 38 μm respectively, and may be made of polydimethylsiloxane.

The first section 25 may be sinuous, or a portion of the first section 25 may be sinuous or curved. In other words, a portion of the first section 25 may comprise a curved unit 40. The channel 20 in the first section 25 may be curved to one side, then back to the dotted main axis line A, past the dotted main axis line A and extends to the opposite side, and return to the dotted centerline A. A curved unit may comprise any curve or extension off the dotted main axis line A. Alternatively, as shown in FIG. 12A, the plurality of curved units 40 of the curved channel 20 in the first section 25 are all disposed offset or on one side of the main axis line A. In an embodiment, the first section 25 comprises 12 curved units 40, each curved unit 40 comprises a curvature centerline radius of 5-500 μm. Still alternatively, as shown in FIG. 1, 6 curved units 40 may disposed upstream the first section 25 on one side of the dotted main axis line A while a further 6 curved unit 40 may be disposed on the opposite side of the dotted main axis line A downstream the earlier 6 curved units 40.

The second section 30 is substantially straight—parallel the dotted main axis line A—compared to the first section 25. A portion of the second section 30 forms an electrical sensing zone 45. Here, a set of 3 electrodes 50 is disposed transverse and adjacent the electrical sensing zone 45. The 3 electrodes may be referred to first 50a, second 50b and third 50c electrodes, the second electrode 50b is disposed intermediate the first and third electrodes, each electrode may be about 20 μm in width and the width and distance between the electrodes can vary from 5 to 30 μm. In various embodiments, the distance between each electrode may be about 20 μm.

The third section 35 comprises a junction 55 wherein the channel 20 splits to form at least two divergent channels 60, 65 that converges into a single channel 70 extending to the at least one outlet 15. As can be seen in FIG. 12A, the two divergent channels 60, 65 that converges into a single channel 70 forms a substantially D-shaped configuration.

The device further comprises an image capturing device 75, such as a camera, disposed adjacent the junction 55 to capture an image of the particle as it passes through the junction 55. The electrodes 50 are configured to detect the presence of the particle arriving at the junction 55 and, upon detection of the particle, they generate a trigger signal to the image capturing device 75 to capture the image of the particle. When triggered, the image capturing device 75 may be configured to record a series of frames at a rate of 1,000-10,000 frames per second, with an exposure time of about 50 μs is for each frame.

The device 5 may further comprise a pump that can be configured to continuously introduce the fluid suspension into the inlet at a flow rate of about 10 to 30 μl/min.

As can be seen in the photo in FIG. 1, the channel 20 may be made of PDMS, which is in turn may be enclosed in a glass substrate. Alternatively, the PDMS channel 20 may be placed or disposed on a glass substrate. The other relevant components of the device 5, e.g. the electrodes 50a, b, c, may be disposed in the glass substrate and placed at, near, adjacent or may even touching the channel 20 to form the electrical sensing zone 45 of the second section 30. In other words, the electrodes 50a, b, c may be patterned on the glass substrate, then the cavity of the channel is sealed with the substrate to enclose it. In various embodiments, the electrodes 50a, b, c may be disposed in the glass substrate below the channel 20. The electrodes 50a, b, c traverse the channel 20 as shown in FIG. 12A, and may or may not be staggered relative to each other.

FIGS. 2(h) and 12B show another embodiment of the invention. Here, two inlets 90a, b are disposed perpendicular to and each on opposite sides of the channel 20 intermediate the second section 30 and third section 35, the two inlets 90a, b are in fluid communication with the channel 20 for introducing a sheath flow to the channel 20 for aligning the particles 85 towards the center of the channel 20. There are two sheath flows 90a, b heading to the centre as the arrows indicate. This allows particles 85 flowing through the channel 20 will be pushed to the centre which leads to a focusing effect. In FIG. 12B, the particle (or cell) 85 is shown in the center of the channel 20 and the direction of flow of the fluid is shown by the arrows. The darker fluid shows the sheath flow coming from inlets 90a, b. The cell 85 enters the junction 55 and is deformed as it enters the third section 35 of the channel 20. The sheath flow may comprise the same fluid as the fluid containing the suspended particles. These two flows 90a, b converge into the main channel 20 flow to pinch the main flow in the channel 20 towards the center of the channel 20. The sheath flow focuses and accelerates the particle 85 in the main flow of the channel 20.

FIG. 12B also shows an enlarged junction space 100. The T-junction 55 has a larger cavity which will slow down the cell velocity when the cell 85 exits the junction 55 so as to obtain a better image quality.

In yet another embodiment of the invention, the third section 35 and outlet 15 forms an outlet section 105. In other words, as shown in FIG. 12A, outlet section 105 comprises the junction 55, divergent channels 60, 65 that converges to form a single channel 70 extending into the outlet 15. In this embodiment, the channel 20 intermediate the second section 30 and third section 35 (i.e. just upstream the junction 55) may split to form a plurality of outlet sections 105. Each outlet section 105 may have its own dedicated image capturing device 75.

In operation of the device 5, the fluid suspension flow through the channel 20 and goes through four stages, 1) particles 85 enter the channel 20 randomly; 2) the particles 85 are aligned to a single streamline by viscoelastic fluids, i.e. aligned in the centre of the channel 20; 3) the particles 85 pass through the electrical sensing zone 45; and 4) the cells enter the junction 55 and are stretched by the hydrodynamic force. Due to the applying of viscoelastic fluids, the device 5 can achieve a large strain at a relatively low flow velocity (e.g. 0.1 m/s), which lows down the corresponding required camera frame rate.

When a particle 85 passes the electrical sensing zone 45, a differential current pulse is generated and fed to a impedance analyzer, where a trigger signal is sent to the image capturing device 75. Then the image capturing device 75 comes on, 50 frames may be taken at a frame rate of 10,000 frames per second. As such, electrical impedance sensing is integrated for an on-demand image recording, which not only avoids the generation of useless images to reduce the workload for image processing, but also enables the ability for selective mechanical phenotyping of particles of interest.

The invention thus also provides for a method for determining a mechanical property of a particle 85 in a fluid suspension by allowing the fluid suspension to flow through the channel 20 via the first 25, second 30, and third 35 sections described above. The method then further includes detecting the presence of the particle 85 arriving at the junction 55 and, upon detection of the particle, generating a trigger signal to the image capturing device 75 to capture the image of the particle. The particles are detected by the electrodes by applying an input voltage of between 0.1 to 10 V (in various embodiments, the input voltage of 0.5 V was used) at about 100 k to 50 MHz (in various embodiments, a frequency of about 5 MHz was used) to the second electrode 50b and calculating a differential current between the first 50a and third 50c electrodes and then feeding the information to an impedance analyser which would generate the trigger signal.

The differential current will cancel the noise in flow.

The deformation of the cell is recorded as images. The softer the cell is, the more it turns from a round shape to an ellipse shape. The evaluation was done by image processing. The software will read how stretched is the cell and define it as deformability as FIG. 2(d) shows. “deformability” means the ability of cell to deform under stress. The flow here carries the cell 85 to accelerate it.

Different types of cells may have different deformability. Through a method of this invention, the value of the deformability can be obtained and hence the different cell types may be determined.

When triggered, the image capturing device 75 records 15 frames at a rate of 2,000 frames per second, with an exposure time of about 50 μl is for each frame. The frame rate may be varied from 1,000 to 20,000 fps with exposure time of about 5 to 100 μs. During this recording cycle, a particle heading to the junction 55 and stretching into an ellipsoid particle dynamic deformation motion may be recorded. When one recording cycle is finished and the particle exit the frame of the image capturing device 75, the image capturing device 75 is turned off and it then waits for the next particle event triggering. The particle deformation images are analysed, the first and last frames in one record cycle are extracted for particle initial diameter and deformability, respectively.

In the method, the particles may be suspended in a viscoelastic fluid and this allows the aligning of the particles to the center of the channel 20 by viscoelastic forces. The viscoelastic fluids are made by adding highly elastic superabsorbent collagen like PEO, PVP or PAA. The viscoelastic fluid may be PEO, PVP, PAA, and its concentration may vary from 0.5 to 3 wt %. In various embodiments, the viscoelastic fluid may be 2 wt % PEO. The fluid is allowed to flow continuously though the channel at a flow rate of about 10 to 30 μl/min.

The operation of the device 5, the microfluidic system, is described in detail in the Example below.

### EXAMPLE

### Materials and Methods

### Working Principles

As shown in FIG. 2, randomly distributed cells at the entry (FIG. 2a) are focused into a single streamline along the axial centreline (FIG. 2b), and guided to the electrical sensing zone (FIG. 2c). At this moment, a differential current pulse is generated due to the single cell translocation event and fed to the impedance analyzer, where a trigger signal is sent to the camera (FIG. 2e-f). While the camera is on, the previously detected single cell is heading to the flow splitting junction (FIG. 2d), stretched under hydrodynamic stress and exits as one recording cycle finishes (FIG. 2g). Next, the cell's dynamic deformation images are analyzed and plotted into 2D scatter plots of initial diameter and cell deformability. (As summarized in flow chart FIG. 3)

As noted, cells flowing through the channel are focused and stretched in viscoelastic fluids. Focusing cells into the three-dimensional center is vital to prevent blurry images when the cell moves out of the focal plane. Furthermore, having cells follow the same streamlines ensures a uniform stretching with identical hydrodynamic forces. Viscoelastic fluids have been widely used in particle and cell focusing. In this work, 2 wt % PEO is chosen to provide adequate throughput and sufficient elastic force. To quantify the forces exerted on individual cells, Reynolds number (Re), a ratio of inertial to viscous forces, is described as Re=ρVDₕ/η. Where ρ is the fluid density, V is the mean velocity of the fluid, Dₕ=2HW/(H+W) is the hydraulic diameter, H is the channel height, W is the channel width, and η is the dynamic viscosity of the fluid (η=0.12 is used in the following formula. Because the flow velocity is relatively low at the flow splitting junction, we assume a constant viscosity in the simplified estimation). Furthermore, the fluid elasticity is characterized by the Weissenberg number (Wi), which in a rectangular channel is given by

$$Wi = \dot{γ} λ = \frac{2 π Q}{{WH}^{2}} ,$$

where \dot{γ} is the shear rate, λ is the fluid relaxation time, Q is the volumetric flow rate. In the above, λ=18λ_{z}(c/c*)^{0.65}, λ_{z} is the Zimm theory predicted relaxation time, c is the viscoelastic fluid concentration and c* is the overlapping concentration. For measuring the relative strength of the elastic force to inertial force, the ratio of Wi to Re, Elasticity number (El) for a square channel defines as

$$EI = \frac{Wi}{Re} = \frac{λη ( W + H )}{ρ {W}^{2} H} .$$

There are two limiting cases, El≈0 and El>>1, denoted inertial dominant and elasticity dominant fluid conditions. This study is at the condition of El>>1, which indicates cells are focused under the condition of negligible inertial and dominant elasticity. The elastic force is theoretically predicted by Ho and Leal that non-uniform normal stress distribution leads to the migration of objects in the fluid directed towards low normal stress difference regions. Huang and Joseph numerically showed that the inertial effect tends to push the objects away from both the wall and channel center while elastic force guides the object towards the centreline in the pressure-driven flow between two parallel walls. The elastic force is expressed as F_{E}=C(r³)∇N₁, proportional to the gradient of the first normal stress difference N₁. Here, C is the elastic lift coefficient, r is the cell radius. N₁=2ληₚ\dot{γ}², ηₚ is the viscosity of PEO solution (η=ηₛ+ηₚ, ηₛ is the solvent viscosity). More details of the focusing mechanism in the curved channel pattern can be found in our previous works. The focusing performance of our platform was evaluated with 10 μm beads, compared with and without PEO solution under a flow rate of 10 μl/min in FIG. 4. It was also evaluated by testing NIH 3T3 cells, in which the cell images recorded by the camera show the cell trajectories at the channel's flow splitting junction (FIG. 5b). These results show nearly 100% of beads and cells are tightly focused along the centreline of the channel in PEO solution.

As cells enter the flow splitting junction, it is notable that the viscoelastic fluids here not only realize focusing but also offer intensive stress at a low flow rate. The total force by three components, the pressure drag force F_{D}=0.5ρCₚAV², the shear force F_{S}=\dot{γ}η(4πr²), and the elastic force F_{E}=C(r³)∇N₁ were roughly estimated. Here, Cₚ=0.47, is the drag coefficient of a sphere, A is the cross-section area of a cell with r=10 μm. At a flow rate of 10 μl/min, the pressure drag is estimated roughly at the order of magnitude of 0.1 nanonewton. The shear force and elastic force at the splitting junction are estimated at the order of magnitude of several micronewton, which is much greater than the pressure drag force. In non-viscoelastic fluids, the shear force and elastic force are negligible, which leads to a small stretching force at such flow rate. In viscoelastic fluids, the elastic force first focuses the cell by moving them to the center of the channel. When cells enter the splitting junction, the elastic force normally acts to compress whilst the shear force acts tangentially to stretch the cell into an ellipsoid. FIG. 5c shows the dynamic cell deformation during the translocation in the splitting junction. Cell subjected to forces is deformed gradually and reaches a maximum deformation when x position approaching zero.

On the other hand, an electrical sensing zone is introduced for on-demand single cell imaging. Three electrodes of 20 μm in width, 20 μm intervals are placed before the flow splitting junction, an input voltage of 0.5 V at 5 MHz is applied to the middle electrode and the differential current (I_{differential}) is calculated from the two-sided electrodes. The differential configuration can cancel out electrical drifting caused by environmental fluctuation (i.e. flow, temperature, conductivity and pH) and achieve a higher signal-to-noise ratio. As the cell passes through the sensing region, it replaces the conductive medium and causes a change in the electrical current. By that, a pair of opposite peaks is transmitted into an impedance spectroscope. When the peak reaches the trigger level, a trigger signal is generated and fed to the camera. Notably, the trigger threshold can filter out small events, such as debris generated from cell apoptosis or lysis, as demonstrated in FIG. 6. Next, for example at a flow rate of 10 μl/min, the camera starts to record 15 frames at a rate of 2,000 frames per second, with an exposure time of 50 μs. The first frame in a recording cycle is used to extract the cell diameter. At this point, the cell remains spherical because it starts to decelerate and is subject to minor stress. In one record cycle, the cell approaches the splitting junction, reaches the channel wall and migrates along the wall for a time span, ensuring the maximum strain is captured at the 15^{th} frame (FIG. 5a). Its aspect ratio evaluates the cell deformability as

$$Deformability = \frac{a}{b} ,$$

where a and b are the length of the long axis and the short axis of the deformed cell, respectively. Our triggering method can directly avoid recording invalid image frames while using the image processing method to reduce invalid frames requires additional time and memory space. For example, the frame differencing method requires 0.039±0.0043 s to process between each frame. It is not feasible for most hydrodynamic stretching studies that require a recording frame rate of up to thousands of frames per second (<0.01 s per image recorded).

### Device Design and Fabrication

The microfluidic device for a single cell is stretching in viscoelastic fluids with impedance triggering consisting of a microchannel made of polydimethylsiloxane (PDMS) and three electrodes patterned on the glass substrate. The microchannel 20 contains 12 curvatures, a flow splitting junction and a D shape exit. The curvature centerline radius is 300 μm, the width and height of the microchannel are 80 and 38 μm, respectively. The device fabrication processes follow standard procedures detailed in Zhou, Y. et al Characterizing Deformability and Electrical Impedance of Cancer Cells in a Microfluidic Device. Anal Chem 2018, 90 (1), 912-919.

### Cell Sample Preparation

The MDA-MB-231, MCF-7 human breast cancer cells, MCF-10A normal breast cells and NIH 3T3 fibroblast cells were purchased from American Type Culture Collection (ATCC at No. HTB-26, HTB-22, CRL-10317 and CRL-1658), cultured using standard protocols as previously described.⁴⁷ NIH 3T3 fixation was performed in 4% methanol-free formaldehyde (ThermoScientific) for 8 mins, following 0.127 M glycine added to the sample solution and retained for 5 mins at room temperature. Cytochalasin B (Sigma-Aldrich) treated NIH 3T3 were prepared by incubating cells in 150 μM Cytochalasin B at 37° C. for two hours. After treatment with chemical reagents, cells were washed, centrifuged and resuspended in 2 wt % PEO solution. The viscoelastic solution was prepared by dissolving PEO (Mw=600 kDa, Sigma-Aldrich) powder into DPBS (Thermo Fisher Scientific) with a concentration of 2 wt %.

For the breast cell lines mixture, MCF-7 and MDA-MB-231 were stained with SYTO 9 and mixed with MCF-10A, respectively. The cultured breast cancer cells were washed 3 times with Hank's balanced salt solution and incubated with 5 μM SYTO 9 staining solution for 30 min. SYTO 9 was then removed, cells were washed, trypsinized, centrifuged, and resuspended in Dulbecco's phosphate-buffered saline (DPBS). Next, stained and unstained cells were mixed to a specific ratio, which was examined by running through a flow cytometry (MACSQuant Analyzer).

### Hydrogel Preparation

Poly-ethylene-glycol-diacrylate based hydrogels (PEGDA hydrogels) were produced by preparing an aqueous solution of 8%, 10%, and 12% v/v poly-ethylene-glycol-diacrylate (455008, Sigma Aldric) respectively with 1% w/v photoinitiator Irgacure 2959, 2-hydroxy-4′-(2-hydroxy-ethoxy)-2-methylpropiophenone (Sigma-Aldrich) in 1×DPBS as the dispersed phase. The aqueous solution was then placed in 80° C. water bath until the photoinitiator Irgacure dissolved and became transparent. Moreover, the continuous phase was light mineral oil (M8410, Sigma Aldric) with 10% v/v Span-80 surfactant (S6760, Sigma-Aldrich). The oil phase and water phase were pumped into a microfluidic device described in our previous work, to generate PEGDA hydrogels of 13 μm in diameter. Afterward, droplets photopolymerization was achieved by exposure with UV light for 30 sec using the OmniCure Series 2000 curing station (Lumen Dynamics). Subsequently, hydrogels were centrifuged, separated from the oil phase, and resuspended in 2 wt % PEO solution for viscoelastic stretching experiments. Meanwhile, hydrogels of different proportions PEGAD were collected and went through a dynamic mechanical analysis (TA Instruments 0800) to obtain their respective Young's modulus.

### Experimental Setup

Samples were continuously introduced into the microfluidic devices using a syringe pump (KD Scientific, Holliston, MA) at a range of flow rates. Simultaneously, the electrical current was received by an impedance spectroscope (HF2IS, Zurich Instruments) and analyzed by a real-time program to send out a trigger signal whenever there was a cell passing through the electrical sensing region. The triggering signal was received by a camera (Photron Inc., San Diego, CA, USA), which started to record 15 frames at a 2,000 frame rate with an exposure time of 50 μs (at a flow rate of 10 μl/min). After the event triggered imaging process was completed, the video was processed offline using a custom-built Python program.

### Results and Discussion

### System Validation by Hydrogel Stretching

To validate and calibrate this microfluidic system for single cell stretching, hydrogels are used to mimic cells. Cells are complex viscoelastic objects linking to the cytoskeleton, membrane, cytoplasm and nucleus. PEGDA hydrogels have simple and uniform properties making them the ideal model for validation experiments. PEGDA hydrogels with Young's modulus of 2.5, 16 and 30 kPa were generated at a uniform diameter of ˜13 μm. Then the deformability of PEGDA hydrogels was measured under the condition of 2 wt % PEO solution and 20 μl/min flow rate. The results are displayed in FIG. 7a, under constant stress the deformability follows a negative linear relationship with Young's modulus in the range of 2.5-30 kPa. PEGDA hydrogels of 30 kPa are beyond the capability of stretching. The mean deformability of 1.06±0.04 suggests the hydrogels approximately remains a spherical shape.

Additionally, the hydrogel of 2.5 kPa yields a deformability of 1.87±0.22. The deformability is comparable with NIH 3T3 fibroblast with deformability of 1.85±0.22 at a flow rate of 20 μl/min (which will be discussed in the next section). Therefore, Young's modulus of NIH 3T3 is deduced to be around 2.5 kPa based on the similar deformability, and it is consistent with the previously reported result of ˜2.1 kPa measured by atomic force microscope.⁴⁹ Measuring hydrogel beads with known Young's modulus provide an intuitive, simple way to relate the value of deformability with the cellular mechanical property.

Furthermore, PEGDA hydrogels of 2.5 kPa were tested in 2 wt % PEO and DPBS solutions under a range of flow rates to prove the enhanced stretching by using viscoelastic fluids (FIG. 7b). In the pure PBS solution, PEGDA hydrogels start to deform slightly only when the flow rate reaches 30 μl/min. While in viscoelastic fluids, PEGDA hydrogels show substantial deformation with high sensitivity to the flow rate. It further demonstrates an effective viscoelastic stretching under low flow rate range.

### Stretching Comparison of Chemical Treated NIH 3T3 Fibroblast Cells

To test the sensitivity of our system for cellular mechanical phenotyping, we compared the deformability of normal and Cytochalasin B (CB) treated two hours NIH 3T3 fibroblasts. Cytochalasin B is a microfilament-disrupting agent, which has been reported to increase cell deformability. FIG. 8a shows the intracellular F-actin depolymerization induced by CB. However, the microfilament is presumably ruptured at high strain, leading to a minor deformability difference of cytoskeletal disrupted cells at high stress. In addition, we measured the deformability at a wide flow rate range of 1-30 μl/min. FIG. 8b shows the deformability difference increases at the low flow rate range but then decreases at the high flow rate range. In particular, the deformability of CB-treated cells reaches a plateau at 10 μl/min. This flow rate was then applied to analyze the deformability difference. Furthermore, fixed cells were measured as control of undeformed cells. Because the fixation process cross-links the proteins in cells which make cells less deformable. FIGS. 9a and 9c present that the deformability distribution has a significant difference at the low flow rate, where the normal fibroblast exhibits moderate deformability (mean=1.54±0.14, Movie S1), fixed fibroblast has the smallest deformability (mean=1.29±0.11) and CB-treated fibroblast presents a deformability increase (mean=1.87±0.23).

FIG. 9b shows the initial and deformed shape by comparing the deformability histogram of cells in the first and last frames. In the first frame, cells yield mean deformability of 1.15±0.11, 1.12±0.06 and 1.16±0.12 for normal, fixed and CB-treated fibroblasts, respectively. It verifies an approximately spherical shape in the first frame. The comparison with the last frame shows an apparent distribution center shift and dispersion expansion, indicating different degrees of cell stretching and the heterogeneity in their cellular biophysical properties. Notably, the deformability of fixed cells in the first frame presents a narrower distribution, because the higher stiffness enables cells to maintain spherical shape under minor stress before entering the flow splitting junction.

Viscoelastic fluids increase the sensitivity of flow rate to applied stress, the deformability of the cells is saturated within a flow rate range of 30 μl/min. Notably, the extensional flow stretching method at large stress magnitude was reported, that the deformability was insensitive to cytoskeletal changes while nuclear contents dominated the deformability. Here, it was demonstrated that the cytoskeletal differences could be probed at lower stress magnitude. The deformability value over a range of flow rates might provide an insight into different cellular components.

### Stretching Comparison of Three Breast Cell Lines

To examine how well this system distinguishes different types of cells, a breast cancer cell classification of MDA-MB-231 and MCF-7 representing high and low invasive carcinoma, with normal MCF-10A cells as control was demonstrated. The cytoskeleton and protein structures of cancer cells are transformed, resulting in the change of deformation ability. Cancer cells are thus typically softer to migrate through tissue. And a decrease in cellular stiffness are correlated with increased invasiveness has been reported in several studies. First, the viability of three cell lines running through this system were investigated at 10, 20, 30 μl/min, respectively. The results present viability above 90% at each flow rate. Therefore, it suggests our method is biocompatible. Next, a successive deformability measurement under a flow rate range from 1 to 30 μl/min was applied to provide an insight of deformability response to stress (FIG. 10). The deformability of three breast cancer cell lines increases with the increase of flow rate. At each flow rate, the deformability is significantly different (p<0.001 based on one-way ANOVA test) between three cell lines. MDA-MB-231 is the softest, followed by MCF-7, and MCF-10A is the least soft cell. Meanwhile, MCF-10A and MCF-7 show a similar trend, which is saturated at a flow rate excess of 20 μl/min, while MDA-MB-231 is deformable under both low and high stress. Then deformability of MDA-MB-231 and MCF-7 are compared with MCF-10A at 10 and 20 μl/min respectively (Movie S4, S5, S6 show representative cells deformation at 10 μl/min). At a flow rate of 20 μl/min, the mean deformability of MDA-MB-231 increases, but it spans a wider distribution as the 50% density contour shows. Thus, the distribution of MDA-MB-231 and MCF-10A are more drifted apart at 10 μl/min. At both flow rates, the distribution of MCF-10A and MCF-7 are considerably overlapped.

For the cell classification, MCF-10A and MDA-MB-231 mixture (FIG. 11a) were investigated at a flow rate of 10 μl/min. Machine learning methods were performed to classify mixture samples of MCF-10A and MDA-MB-231 at different ratios. Support vector machine (SVM) with the radial basis function kernel and 5-fold cross validation was used. The algorithms to apply SVM are available in sklearn python package. SVM trains a model with labeled data to find a plane that best separates different populations, the basic ideas and its advanced method have been explained by Smola et al. The data for three cell lines (up to 2,000 data points for each) are fed into SVM in pairs respectively to train a model that has an accuracy (the fraction of correctly classified sample) of 0.98. Then the predicted results are shown in FIG. 11. For the mixture of 1:1, SVM predicts the population ratio of MCF-10A to MDA-MB-231 as 0.9:1, and flow cytometry (FCM) measures the ratio as 0.97:1 (FIG. 11). For the mixture of 5:1, the results are 5.03:1 vs. 5.33:1. The classifications of these two different mixture ratios are both comparable with the flow cytometry results. With respect to a population less separated, a mixture of MCF-7 with MCF-10A, a distribution shift indicates a change in population content at different ratios. This invention provides good quantitative prediction results for cell clusters (i.e., high invasive cancer cells MDA-MB-231 and normal cells MCF-10A) that have a large deformability difference. For cell clusters with similar deformability distribution, the distribution shifting can shed light on a population change.

### Conclusions

In this invention, a microfluidic system capable of single cell hydrodynamic stretching and electronically triggered single cell imaging, enabling high-throughput mechanical phenotyping at the single cell level was presented. It was demonstrated that viscoelastic fluids can significantly enhance the stress on cells, allowing prominent stretching at a much lower flow speed than existing mechanical phenotyping systems. In addition, the ability to detect the arrival of single cells for electronically triggered on-demand imaging ensures that every captured frame contains a cell image for extracting mechanical phenotypes. This electronically triggered on-demand imaging avoids the generation of useless images to reduce the workload for image processing and potentially enables the ability for selective mechanical phenotyping of cells of interest. Hydrogel microbeads with known mechanical properties to validate the sensitivity of the developed microfluidic mechanical phenotyping system were synthesized, and the hydrogel calibration can help gain insight into cellular mechanical properties (e.g., Young's modulus). The mechanical phenotyping of normal and chemically treated NIH 3T3 cells demonstrated the sensitivity of this system with statistical significance. Besides, measuring deformability over a range of flow rates shows that cells present different deformation abilities under low or high stress. Furthermore, the accurate classification results between breast cancer cells (MDA-MB-231, MCF-7) and normal cells (MCF-10A) show the great potential of this mechanical phenotyping approach for cancer diagnosis. In summary, the integration of single cell hydrodynamic stretching and electronically triggered on-demand imaging provides a new solution for low-cost, real-time, label-free and high-throughput cellular mechanical phenotyping in a wide range of biomedical applications.

Whilst there has been described in the foregoing description preferred embodiments of the present invention, it will be understood by those skilled in the technology concerned that many variations or modifications in details of design or construction may be made without departing from the present invention.

1. A device for determining a mechanical property of a particle in a fluid suspension, the device comprising:
(a) at least one inlet for introducing the fluid suspension;
(b) at least one outlet for discharging the fluid suspension;
(c) a channel in fluid communication with and intermediate the at least one inlet and the at least one outlet, the channel comprising first, second and third sections, the second section disposed intermediate the first and third portions, wherein
(i) the first section is disposed adjacent the at least one inlet, a portion of the first section is curved to form at least one curved unit;
(ii) the third section is adjacent the outlet, the third section comprises a junction wherein the channel splits to form at least two divergent channels that converges into a single channel extending to the at least one outlet; and
(iii) the second section comprises an electrical sensing zone;
(d) at least one electrode disposed adjacent the electrical sensing zone;
(e) an image capturing device disposed adjacent the junction to capture an image of the particle as it passes through the junction,
wherein the at least one electrode is configured to detect the presence of the particle arriving at the junction and, upon detection of the particle, to generate a trigger signal to the image capturing device to capture the image of the particle.

2. The device according to claim 1, wherein the first section is sinuous and comprises a plurality of curved units.

3. The device according to claim 2, wherein the first section comprises 12 curved units, each curved unit comprises a curvature radius between 50 μm to 500 μm.

4. The device according to any one of the preceding claims, wherein the second section is substantially straight.

5. The device according to any one of the preceding claims, wherein a plurality of electrodes are disposed transverse the channel.

6. The device according to claim 5, wherein the plurality of electrodes comprises three electrodes, a first, second and third electrodes, the second electrode is disposed intermediate the first and third electrodes, each electrode is about 5-30 μm in width and the distance between each electrode is about 5-30 μm.

7. The device according to claim 6, wherein a current having an input voltage of 0.1-5 V and a frequency of 0.1-10 MHz is applied to the second electrode and a differential current is calculated across the first and third electrodes.

8. The device according to any one of the preceding claims, wherein the width and height of the channel are about 80 and 38 μm respectively.

9. The device according any one of the preceding claims, wherein when triggered, the image capturing device is configured to record a series of frames at a rate of 1,000-10,000 frames per second, with an exposure time of about 50 μs is for each frame.

10. The device according to any one of the preceding claims, wherein the channel is made of polydimethylsiloxane.

11. The device according to any one of the preceding claims, further comprising two inlets disposed perpendicular to and each on opposite sides of the channel intermediate the second and third sections, the two inlets in fluid communication with the channel for introducing a sheath flow to the channel for aligning the particles towards the center of the channel.

12. The device according to any one of the preceding claims, wherein the third section of the channel which splits to form at least two divergent channels that converges into a single channel forms a substantially symmetrical configuration.

13. The device according to any one of the preceding claims, wherein the third section and outlet forms an outlet section and, wherein the channel intermediate the second and third section splits to form a plurality of outlet sections.

14. The device according to any one of the preceding claims, further comprising a pump, the pump is configured to continuously introduce the fluid suspension into the inlet at a flow rate of about 10 to 30 μl/min.

15. A method for determining a mechanical property of a particle in a fluid suspension, the method comprising:
(a) allowing the fluid suspension to flow through a channel, the channel comprising first, second and third sections, wherein the first section comprising at least one curved unit, the second section comprising an electrical sensing zone, and the third section comprises a junction wherein the channel splits to form at least two divergent channels; and
(b) detecting the presence of the particle arriving at the junction and, upon detection of the particle, generating a trigger signal to an image capturing device to capture the image of the particle.

16. The method according to claim 15, wherein the first section is sinuous and comprises a plurality of curved units.

17. The method according to claim 16, wherein the first section comprises 12 curved units, each curved unit comprises a curvature radius between 50 μm to 500 μm.

18. The method according to any one of claims 15 to 17, wherein the particle is suspended in a viscoelastic fluid, the method further comprising aligning the particle to the center of the channel by viscoelastic forces.

19. The method according to claim 18, wherein the viscoelastic fluid is 0.5 to 3 wt % PEO.

20. The method according to any one of claims 15 to 19, wherein 3 electrodes are disposed transverse the channel adjacent the electrical sensing zone to detect the presence of the particle arriving the junction, the 3 electrodes comprising a first, a second and third electrodes, the second electrode is disposed intermediate the first and third electrodes, each electrode is about 20 μm in width and the distance between each electrode is about 20 μm.

21. The method according to claim 20, further comprising applying a current having an input voltage of 0.1-10 V and frequency of 0.1-50 MHz to the second electrode and calculating a differential current across the first and third electrodes.

22. The method according to any one of claims 15 to 21, wherein when triggered, the image capturing device records a series of frames at a rate of 1,000-10,000 frames per second, with an exposure time of about 50 μs for each frame.

23. The method according to any one of claims 15 to 22, wherein the width and height of the microchannel are about 80 and 38 μm respectively, and the channel is made of polydimethylsiloxane.

24. The method according to any one of claims 15 to 23, wherein the second section is substantially straight.

25. The method according to any one of claims 15 to 24, further comprising introducing a sheath flow into the channel perpendicular to and on opposite sides of the channel intermediate the second and third sections, the sheath flow for aligning the particles towards the center of the channel.

26. The method according to any one of claims 15 to 25, wherein the at least two divergent channels of the third section converges into a single channel and extends to an outlet to discharge the fluid suspension, the third section forms a substantially symmetrical configuration.

27. The method according to claim 26, wherein the third section and outlet forms an outlet section, and wherein the channel intermediate the second and third section splits to form a plurality of outlet sections allowing for a plurality of junctions for the capturing of images of particles passing through the junctions.

28. The method according to any one of claims 13 to 23, wherein the fluid is allowed to flow continuously though the channel at a flow rate of about 10 to 30 μl/min.

29. A device or method for determining a mechanical property of a particle in a fluid suspension substantially as herein described with reference to any one of the examples or to any one of the accompanying drawings.
